(19) United States
(12) Patent Application Publication
(10) Pub. No.: US 2017/0220930 A1
(43) Pub. Date: Aug. 3, 2017

(54) AUTOMATIC PROBLEM ASSESSMENT IN MACHINE LEARNING SYSTEM

(71) Applicant: Microsoft Technology Licensing, LLC, Redmond, WA (US)

(72) Inventors: Damon Robert Hachmeister, North Grafton, MA (US); Sudarshan Raghunathan, Cambridge, MA (US); Andy James Linfoot, Boston, MA (US); Debi Prasad Mishra, Seattle, WA (US); Parry Jones Reginald Husbands, Waltham, MA (US)

(21) Appl. No.: 15/011,293

(22) Filed: Jan. 29, 2016

(51) Int. Cl. G06N 5/02; G06N 99/00

(52) U.S. Cl. CPC G06N 5/02; G06N 99/005

(57) ABSTRACT

A machine learning problem assessment system that identifies potential machine learning problems in a machine learning system in which learning code evaluates data to correlate estimated learned data with data patterns. An accessing component accesses the learning code and/or the data that the learning code evaluates. A problem identifies component estimates, based on the accessed code and/or data, that there is a potential problem with machine learning system. A rectification component at least partially automatically rectifies the identified potential problem with the machine learning system by performing a computerized action on the machine learning system. The identified potential problem may affect quality (e.g., appropriateness of conclusions) and/or performance (e.g., speed) of the learning of the machine learning system.

### BACKGROUND

Computing systems and associated networks have revolutionized the way human beings work, play, and communicate. Nearly every aspect of our lives is affected in some way by computing systems. Of course, proper functioning of a computing system relies on software that provides the appropriate function, and data that provides appropriate input and configuration for the software. These functions are now being asked to perform increasingly complex tasks. One common strategy to create these functions is to construct approximations based on observations. When the amount and variety of data input into an algorithm is limited, the algorithm can often be drafted so as to output a deterministic output. However, in this information age, with ever higher levels of data being made available, it is more difficult to draft deterministic algorithms that use the massive amounts of data in an optimum way.

The sheer volume of data represents a world or universe of data patterns that lend themselves to pattern recognition, and the making of inferences based on the recognized patterns. This process is referred to as “learning” as human beings also learn by observing patterns, and making inferences therefrom. For instance, a child may learn what a car is by hearing multiple references of the word “car” while a car is being observed by the child. A child repeats this process for all aspects of language thereby allowing the child, through appropriate pattern recognition, to quickly formulate and improve their native language skills. Such pattern matching learning occurs for all aspects of learning. Machines also now have a universe that they can observe—a universe of data, and can also make new inferences based on pattern matching.

Machine learning is a complex technical field. There are a wide variety of ways that machine learning can go awry. For instance, a machine might not make the proper inferences due to underfitting of the data to the inference. This might occur if there is simply not enough data to make a meaningful correlation with an inference. In other words, the data is underfitted to the inference. On the opposite extreme, there may be an overfitting problem in which the inference is too literally matched with the data patterns. For instance, the inference may be drawn based on too much importance attributed to a portion of data patterns. Furthermore, the data itself may not be sufficiently stratified such that important patterns are not smoothly distributed throughout the universe of data.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to a machine learning problem assessment system that identifies potential machine learning problems in a machine learning system in which learning code evaluates data to correlate estimated additional data with data patterns. An accessing component accesses the learning code and/or the data that the learning code evaluates. A problem assessment component identifies, based on the accessed code and/or data, that there is a potential problem with the machine learning system. A rectification component at least partially automatically rectifies the identified potential problem with the machine learning system by performing a computerized action on the machine learning system. The identified potential problem may affect quality (e.g., appropriateness of conclusions) and/or performance (e.g., speed) of the learning of the machine learning system.

In some embodiments, the problem assessment component performs dynamic analysis of the learning process by identifying a potential problem based on evaluation of at least one of multiple stages of the learning code. For instance, the problem assessment component may evaluate the state of the learning after each piece of data is evaluated by the learning code. The rectification performed by the rectification component might be performed fully automatically or perhaps automatically after approval by a user. Examples of rectification include, for instance, preparing the data, stratifying the data, adjusting or creating a split of the data, replacing or adjusting the learning code, or the like.

The task of manually sorting through the learning code and data to identify potential problems with machine learning is fraught with difficulty due to the high volume of data involved, and the potential complexity of the learning code. This can lead to incorrect conclusions, even after extensive analysis, potentially leaving some problems unresolved. Using the principles described herein, a computing system identifies potential problems, resulting in faster detection of learning difficulties in a machine learning system. Furthermore, the rectification of the learning difficulty is also with the guidance or completely automated by the computing system, thereby quickly improving not just detection, but also rectification of a wide variety of potential problems with the machine learning system with a potential wide variety of solutions.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed, and which has thereon an executable component;

FIG. 2 illustrates a computing system environment that includes a machine learning problem assessment system as well as a machine learning system;

FIG. 3 illustrates a flowchart of a method for a machine learning problem assessment system to identify potential machine learning problems in a machine learning system, which method may be performed in the computing system environment of FIG. 2;

FIG. 4 illustrates a flowchart of a method of one example of partially automatically rectifying a problem, which may be performed by the rectification component of FIG. 2 as part of the rectification act of FIG. 3; and

FIG. 5 illustrates a more detailed structure of a machine learning system, and represents an example of a machine learning system of FIG. 4.

### DETAILED DESCRIPTION

At least some embodiments described herein relate to a machine learning problem assessment system that identifies potential machine learning problems in a machine learning system in which learning code evaluates data to correlate estimated additional data with data patterns. An accessing component accesses the learning code and/or the data that the learning code evaluates. A problem assessment component identifies, based on the accessed code and/or data, that there is a potential problem with the machine learning system. A rectification component at least partially automatically rectifies the identified potential problem with the machine learning system by performing a computerized action on the machine learning system. The identified potential problem may affect quality (e.g., appropriateness of conclusions) and/or performance (e.g., speed) of the learning of the machine learning system.

In some embodiments, the problem assessment component performs dynamic analysis of the learning process by identifying a problem based on evaluation of at least one of multiple stages of the learning code. For instance, the problem assessment component may evaluate the state of the learning after each piece of data is evaluated by the learning code. The rectification performed by the rectification component might be performed fully automatically or perhaps automatically after approval by a user. Examples of rectification include, for instance, preparing the data, stratifying the data, adjusting or creating a split of the data, replacing or adjusting the learning code, or the like.

The task of manually sorting through the learning code and data to identify potential problems with machine learning is fraught with difficulty due to the high volume of data involved, and the potential complexity of the learning code. This can lead to incorrect conclusions, even after extensive analysis, potentially leaving some problems unresolved. Using the principles described herein, a computing system identifies potential problems, resulting in faster detection of learning difficulties in a machine learning system. Furthermore, the rectification of the learning difficulty is also with the guidance or completely automated by the computing system, thereby quickly improving not just detection, but also rectification of a wide variety of potential problems with the machine learning system with a potential wide variety of solutions.

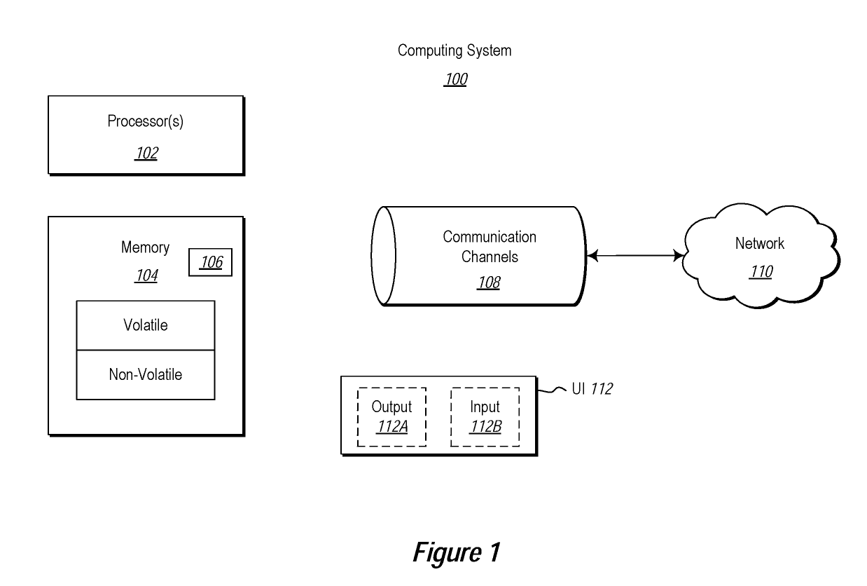

Some introductory discussion of a computing system will be described with respect to FIG. 1. Then, the structure and operation of the machine learning problem assessment system will be described with respect to subsequent figures.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module” or the like may also be used. As used in this description and in the case, these terms are also intended to be synonymous with the term “executable component”, and thus also have a structure that is well understood by those of ordinary skill in the art of computing, regardless of whether or not such a component is further modified (e.g., as in the case of the rectification component, accessing component, and problem estimation component).

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

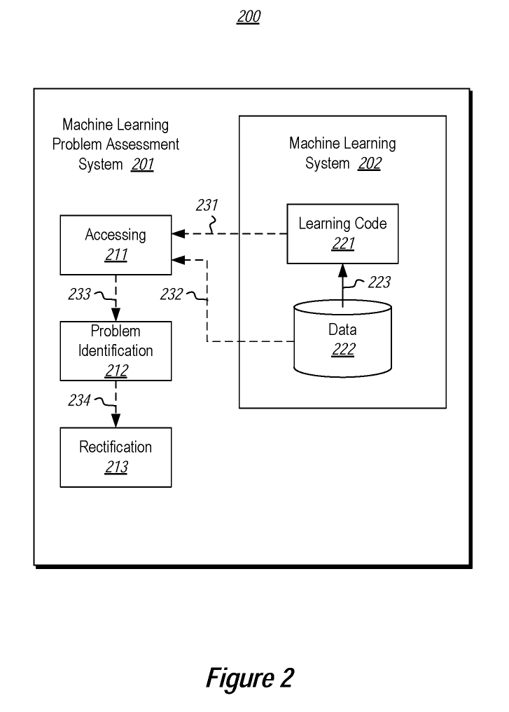

FIG. 2 illustrates a computing system environment 200 that includes a machine learning problem assessment system 201 as well as a machine learning system 202. The machine learning problem assessment system 201 may be, for instance, structured as described above for the computing system 100 of FIG. 1. In that case identified potential problems may be identified via the output mechanisms 112A on of such a computing system, the user may be given a control to initiation rectification of the potential problem, and/or the user may be displayed progress regarding the rectification. The machine learning system 202 may also be structured as described above for the computing system 100. Although not required, the machine learning problem assessment system 201 and the machine learning system 202 may be operated upon a single computing system.

The machine learning problem estimation system 201 includes multiple executable components 211, 212 and 213. Each of the executable components has the structure described above for the computing system 106 of FIG. 1. In particular, the machine learning system problem assessment system 201 includes an accessing component 211, a problem identification component 212, and a rectification component 213. The machine learning system 202 includes learning code 221 as well as data 222 that the learning code 221 uses (as represented by arrow 223) to learn. For instance, the learning code 221 uses the data 222 to correlate data patterns with estimated additional data (i.e., learned data). For instance, the estimated additional data may represent an assertion that the learning code 221 estimates as being true about the correlated data patterns. For instance, the estimated data may include a classification of the correlated data patterns. As another example, the estimated data may include an estimated function of the correlated data pattern.

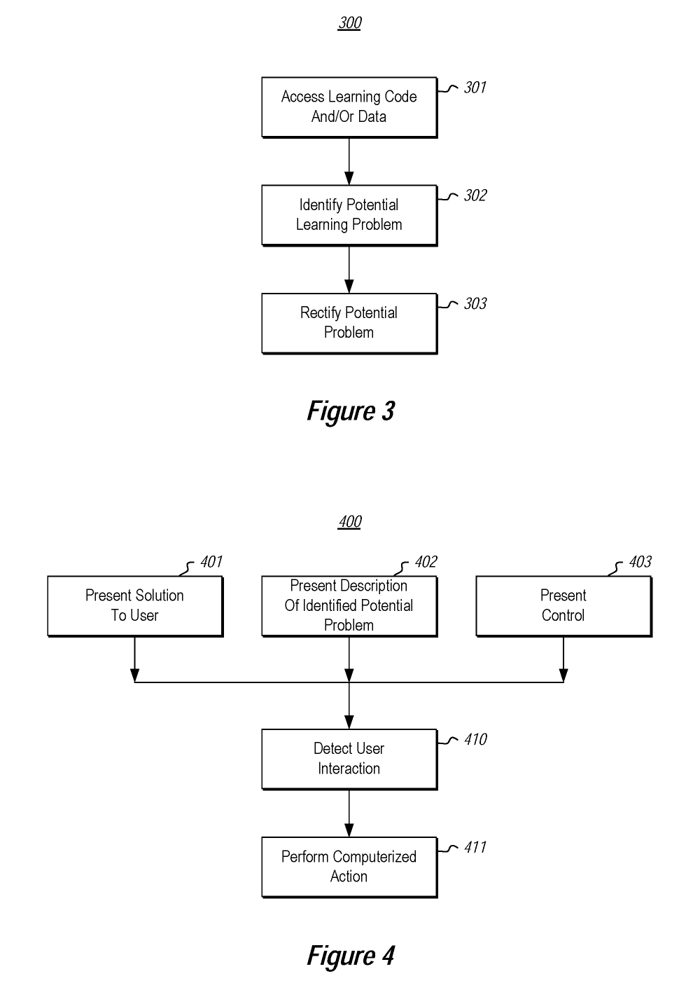

FIG. 3 illustrates a flowchart of a method 300 for a machine learning problem assessment system to potential machine learning problems in a machine learning system. As an example, the method 300 may be performed by the machine learning problem estimation system 201 of FIG. 2 to identify potential machine learning problems in the machine learning system 202 of FIG. 2. Accordingly, the method 300 of FIG. 3 will now be described with respect to the environment 200 of FIG. 2.

An accessing component of the machine learning problem assessment system accesses at least one of the learning code and the data that the learning code evaluates (act 301). For instance, the accessing component 211 accesses at least one of the learning code 221 and the data 222. This is represented by arrows 231 and 232 in FIG. 2.

A problem identification component then identifies, based on the accessed code and/or data, that there is a potential problem with the machine learning system (act 302). This flow is represented in FIG. 2 by arrow 233. For instance, the problem identification component 212 identifies, based on the accessed learning code 221 and/or the data 222, that there is a potential problem with the machine learning system 202.

A rectification component that at least partially automatically rectifies the identified problem with the machine learning system by performing a computerized action on the machine learning system (act 303). For instance, as represented by the flow of the arrow 234, the rectification component 213 at least partially automatically rectifies the identified problem with the machine learning system 202 that was identified by the problem identification component 213.

For instance, FIG. 4 illustrates a flowchart of a method 400 of one example of partially automatically rectifying a problem, which may be performed by the rectification component (such as the rectification component 213). In accordance with the method 400, the rectification component causes at least one solution to the identified potential problem to be presented to the user for approval (act 401). The rectification component may cause a description of the identified potential problem to be displayed to the user (act 402). The rectification component also presents an approval control (act 403). Upon the rectification component detecting that the user has interacted with the approval control in a certain way (act 410), the rectification component then performs the computerized action that rectifies the identified potential problem (act 411). The visual representation of the solution (of act 401), the description of the identified potential problem (of act 402), and/or the control (of act 403) may be displayed on, for example, the display 112 in the case that the rectification component 213 is executed on the computing system 100.

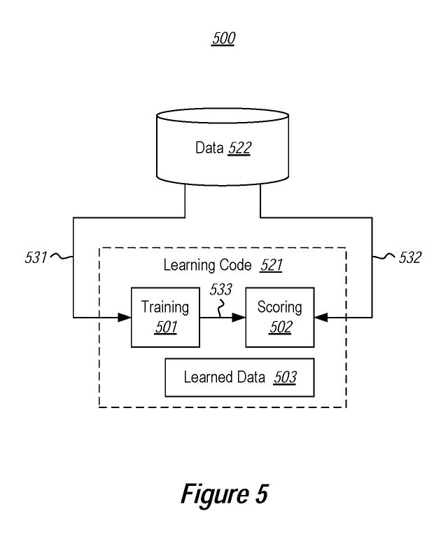

FIG. 5 illustrates a more detailed structure 500 of a machine learning system, and represents an example of a machine learning system 202 of FIG. 2. The data 522 is an example of the data 222 of FIG. 2. The learning code 521 is an example of the learning code 521 of FIG. 2. When run, the learning code 521 operates a process of learning in two phases—a training phase and a scoring phase. Training is accomplished via a training component 501, and scoring is accomplished via the scoring component 502.

During the training phase, the training component 501 receives data (as represented by arrow 531) from the data 522, one portion at a time, evaluates data patterns within the data portion in accordance with the learning code 521, and estimates in accordance with the learning code 521 additional data (i.e., learned data) based on the existence of a data pattern. The estimation may have a certain confidence level which may increase with each addition sampling of data portions. As confidence levels increase regarding newly estimated data, learning is achieved. More specifically, the learning involves estimating and gaining confidence in new information based on observation of data patterns. This is the essence of learning, and is not limited to human beings. This newly learned data is represented by learned data 503 within the training component 501.

However, machines can have difficulties and/or inefficiencies in learning. To determine how reliable the learned data 503 is, different data portions are fed to both the training component 501 and the scoring component 502. During this scoring phase, the learned data 503 is applied using processes of the learning code 521 to make an estimation of learned data based on patterns within the data. The training component 501 provides the estimation to the scoring component 503 (as represented by arrow 533). The data is also provided to the scoring component 502 (as represented by the arrow 532) so that the scoring component 502 can determine whether or not the estimation is correct. The scoring component 502 then generates a These training and scoring phases may repeated to determine a rate of learning. For instance, the rate of learning may be a function of how many new pieces of learned data is estimated in a given timeframe, the significance of the new data, and/or the rate at which confidence is gained in estimations of new learned data.

Accordingly, learning occurs in phases of training and scoring. Likewise, training itself occurs in discrete bits in which one data portion is evaluated at a time to estimate and increase confidence levels in learned data. Returning back to FIG. 2, the problem identification component 212 may identify potential problems by evaluating the state of learning after each of these processing stages, potentially as often as after each data portion. By so doing, the problem identification component 212 may detect whether the learning is occurring efficiently after each data portion. In this sense, the problem estimation component 212 may be like a teacher peeking into the mind of a child to determine what the child learns in response to each and every sensory event (e.g., each time the child sees, hears, smells, touches, or tastes something) to evaluate the resulting thoughts after each event. The problem identification component 212 may repeat this process with respect to the learned data innumerable times at high granularity to identify potential problems in the machine learning system. This is true regardless of whether or not the problem relates to the quality of learning (e.g., the learned data tends to be false), and the performance of learning (e.g., the rate of learning true data is perhaps slow).

Various types of problems with machine learning will now be described. For each problem type, a mechanism for identifying the problem will be described, along with one or more potential solutions to the identified problem. Recall that such solutions may be at least partially automatically performed by the rectification component 213 of FIG. 2.

Some problems relate to the suitability of the learning code to the data that the learning code is evaluating. For instance, there may be insufficient data of the proper type for the learning code to be able to learn any new learned data. As an example, learning code that is designed to learn to read by evaluating consecutive pieces of written text in the language desired to be learned will not be especially efficient at interpreting stock market data to make predictions about possible future market trends.

To automatically estimate this type of mismatch problem, the problem identification component 212 might, for instance, perform static analysis of the learning code and the data. For instance, metadata associated with the learning code might indicate an optimum set of uses for the learning code. Static analysis of the data might involve reviewing the data to determine that it is of a certain type of data that is not matched to such an optimum set of uses. Alternatively or in addition, through dynamic analysis involving evaluating the very process of learning (at each of multiple stages of the learning process), the problem identification component 212 may detect that the amount of learned data and/or the confidence levels in that learned data is simply not increasing as a result of the learning code.

In this case, computerized action to resolve this problem may be to switch the learning code with other learning code. For instance, in the example in which language learning code is used to evaluate stock market data, the language learning code may be switched out entirely for learning code that is more adapted to detecting trends, cycles or other patterns across one or more parameters (such as time). When there is less of an apparent mismatch between the data and the learning code, one or more parameters of the learning code may be adjusted.

Other detectable problems might include underfitting of the data to the learning code. In this case, there is simply insufficient data for the learning code to learn anything or draw any meaningful inferences. In that case, automated rectification might involve augmenting the data with other compatible data having similar parameters. If the underfitting of the data is due to inefficiencies of the learning code, the learning code may be switched for other learning code, or perhaps parameters of the learning code may be adjusted to improve the efficiency in learning.

The identified problem might be overfitting of the data to the learning code. In this case, the learning code is overly literal, and draws conclusions too quickly. As an example, some learning code may infer that cars are all objects that have seats inside. Here, the learning code is clearly too focused on the presence or absence of seats inside of another object. Rather, the learning code should also focus on other relevant patterns also such as whether the object has wheels, the number of wheels that the object has, whether the object is self-propelled, and so forth. This overfitting problem may be detected by dynamic analysis along each increment of the learning process. Once the problem assessment system determines that the training system has learned data that is false based on overweighting of one relevant data pattern over other data patterns, the problem estimation component might estimate that there is a problem with the learning code overfitting.

In that case, the rectification component 213 may alter the learning code so that it is more capable of properly weighting all relevant portions of the data patterns. Alternatively or in addition, the rectification component 213 might expose the learning code to more diversified data to allow the learning code to discover other relevant data patterns. For instance, the data might also be changed so that the learning code may be exposed to objects that have seats inside of them (trains, houses, airplanes) so that the learning code can see that the presence or absence of seats within an object is not determinative and that other data patterns are also relevant. In this way, the learned data may include a more nuanced understanding of what a car is by weighting other data patterns appropriately.

The identified problem could also be improper scoring of the learning code. For instance, if a prediction is being made about a fairly rare event, if the learning code simply predicted that the event was not going to happen, then the learning code would be right almost all of the time. The scoring could thus unjustly give the learning code a high score. Such a high score might give the learning code the wrong idea about how well it has learned, thereby perhaps reinforcing bad learning. In this case, the rectification component 213 could change the scoring code or alter one or more of its parameters. For instance, a correct prediction of the absence of a rare event may be weighted much more lightly that a correct prediction of the rare event itself.

Other computerized actions might involve preparing the data itself. For instance, if some relevant patterns appear more densely in some spots of the data that in other parts of the data, the data might be stratified such that the relevant data pattern is more evenly distributed. Such might lead to learning difficulty if the relevant data patterns are found in the data used to score, but not the data used to train. Such might also lead to scoring difficulty if the relevant data patterns are found in the data used to train, but not the data used to score.

In some cases, the identified problem may occur due to an improper splitting of the data between the data used to train and the data used to score. For instance, if the same data is used to train and score, then scoring really does not test the effectiveness of the training. The training could simply memorize the data that it viewed, without learning anything new at all from that data, simply because, during the scoring process, the training component has already seen the data.

In other cases, there may be too much data used for training and too little for scoring. In that case, the rectification component may cause more data to be used to train, and less to score.

Accordingly, the principles describe herein provide an effective automated mechanism for identifying potential problems within a machine learning system, and an at least partially automated mechanism for rectifying such identified problems. A wide variety of computerized actions might be performed in responding to an estimated problem including changing out or altering the learning code, preparing or augmenting the data used to train, creating or modifying a split of data used to train and score, and/or adjust the scoring code. Because the process is automated, potential problems with machine learning may be detected early, allowing the machine learning system to be corrected quickly, and thereby learn faster.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A machine learning problem assessment system that identified potential machine learning problems in a machine learning system in which learning code evaluates data to correlate estimated learned data with data patterns, the machine learning problem estimation system comprising:
an accessing component that accesses at least one of 1) the learning code, and 2) the data that the learning code evaluates;
a problem identification component that identifies, based on the accessed code and/or data, that there is a potential problem with machine learning system; and
a rectification component that at least partially automatically rectifies the potential problem with the machine learning system by performing a computerized action on the machine learning system.

2. The machine learning problem assessment system in accordance with claim 1, the problem identification component further identifying based on evaluation of at least one of a plurality of processing stages of the learning code.

3. The machine learning problem assessment system in accordance with claim 1, the rectification component automatically rectifying the identified potential problem with the machine learning system.

4. The machine learning problem assessment system in accordance with claim 1, the rectification component causing at least one solution to the identified potential problem to be presented to the user along with an approval control that the user may actuate to trigger the rectification component to automatically rectify the identified potential problem with the machine learning system.

5. The machine learning problem assessment system in accordance with claim 4, the rectification component also causing a description of the identified potential problem to be displayed to the user.

6. The machine learning problem assessment system in accordance with claim 1, the identified potential problem being underfitting of the data to the learning code.

7. The machine learning problem assessment system in accordance with claim 1, the identified potential problem being overfitting of the data to the learning code.

8. The machine learning problem assessment system in accordance with claim 1, the identified potential problem being improper scoring of the learning code.

9. The machine learning problem assessment system in accordance with claim 1, the computerized action comprising switching the learning code for other learning code.

10. The machine learning problem assessment system in accordance with claim 1, the computerized action comprising adjusting the learning code.

11. The machine learning problem assessment system in accordance with claim 10, the adjusting of the learning code comprising regularization of the learning code.

12. The machine learning problem assessment system in accordance with claim 1, the computerized action comprising augmenting the data that is used by the learning code.

13. The machine learning problem assessment system in accordance with claim 1, the computerized action comprising preparing the data that is used by the learning code.

14. The machine learning problem assessment system in accordance with claim 1, the estimated problem being failure to properly split the data between use in training and scoring.

15. The machine learning problem assessment system in accordance with claim 14, the computerized action comprising creating a different split of the data between use in training and scoring.

16. The machine learning problem assessment system in accordance with claim 14, the computerized action comprising creating a non-overlapping split of the data between use in training and scoring.

17. The machine learning problem assessment system in accordance with claim 1, the identified potential problem being insufficiently stratification in the data.

18. The machine learning problem assessment system in accordance with claim 17, the computerized action being performing further stratification of the data.

19. A computer program product comprising one or more computer-readable storage media having thereon computer-executable instructions that are structure such that, when executed by one or more processors of the computing system, configure the computing system to instantiate and/or operate a plurality of executable components in a machine learning problem assessment system that identifies potential machine learning problems in a machine learning system in which learning code evaluates data to correlate estimated learned data with data patterns, the plurality of executable components comprising:
an accessing component that accesses at least one of 1) the learning code, and 2) the data that the learning code evaluates;
a problem identification component that identifies, based on the accessed code and/or data, that there is a potential problem with machine learning system; and
a rectification component that at least partially automatically rectifies the identified potential problem with the machine learning system by performing a computerized action on the machine learning system.

20. A method for a machine learning problem assessment system to identify potential machine learning problems in a machine learning system in which learning code evaluates data to correlate estimated learned data with data patterns, the method comprising:
an act of an accessing component accessing at least one of 1) the learning code, and 2) the data that the learning code evaluates;
an act of a problem identification component identifying, based on the accessed code and/or data, that there is a potential problem with machine learning system; and
an act of a rectification component at least partially automatically rectifying the identified potential problem with the machine learning system by performing a computerized action on the machine learning system.

21. The method in accordance with claim 20, the identified potential problem affecting quality of learning of the machine learning system.

22. The method in accordance with claim 20, the identified potential problem affecting performance of the machine learning system.
